(19) United States
(12) Patent Application Publication
(10) Pub. No.: US 2026/0277576 A1
(43) Pub. Date: Sep. 17, 2026

(54) PROGRAM TRANSLATION THROUGH CODE DISTILLATION

(71) Applicant: MICROSOFT TECHNOLOGY LICENSING, LLC, Redmond, WA (US)

(72) Inventors: Colin Bruce CLEMENT, Seattle, WA (US); Neelakantan SUNDARESAN, Bellevue, WA (US); Yufan HUANG, Shanghai (CN); Mengnan QI, Shanghai (CN); Maoquan WANG, Shanghai (CN); Yongqiang YAO, Shanghai (CN)

(21) Appl. No.: 19/474,934

(22) PCT Filed: Jun. 19, 2023
(86) PCT No.: PCT/CN2023/101039

§ 371 Date: Oct. 13, 2025

(51) Int. Cl. G06F 8/51

(52) U.S. Cl. CPC G06F 8/51

(57) ABSTRACT

A source code translation system translates a source code snippet in an original source code programming language into distilled code that preserves the core semantics, logic flow, and data flow of the source code snippet in a language-independent format. The distilled code is then translated into a semantically-equivalent source code snippet in a different programming language by a decompiler. The decompiler is configured as a neural transformer model with attention pre-trained for translation using masked language modeling, denoising auto-encoding and multilingual program generation. The decompiler translates the distilled code into one of several different high-level programming languages.

### BACKGROUND

A source code transcompiler translates source code written in a source programming language into semantically-equivalent source code program written in a different programming language. Traditional approaches rely on a one-to-one relationship between the source programming language and the target programming language and utilize rewrite rules tailored to perform the translation from the source programming language to the target programming language.

However, generating a transcompiler is often not practical. The task requires an expertise in both programming languages where there may be limited expertise in legacy programming languages (e.g., COBOL, Fortran, PL/I). In addition, the task is further complicated since different programming languages have different grammars and syntactic structures, and rely on distinctive platform APIs, standard-library functions, and type systems that vary across multiple programming languages.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A source code translation system contains a distilled code compiler and a decompiler. The distilled code compiler translates a source code snippet written in a high-level programming language into distilled code that maintains the core semantics, logic flow and data flow of the original source code snippet without language dependent source code constructs. The decompiler translates the distilled code into a semantically-equivalent source code snippet in a different programming language. The decompiler is configured as a neural transformer model with attention pre-trained for translation using through masked language modeling, denoising auto-encoding and multilingual program generation. The decompiler translates the distilled code into one of several different high-level programming languages.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary configuration of a source code translation system using code distillation.

FIG. 2 illustrates an exemplary configuration of the decompiler as a neural transformer model with attention.

FIG. 3 is a flow chart illustrating an exemplary method for training and deploying a decompiler for source code translation.

FIG. 4 is a flow chart illustrating an exemplary method of the pre-training the neural transformer model with attention as a decompiler.

FIG. 5 is a flow chart illustrating an exemplary method for translating a source code snippet written in one high-level programming language into a different high-level programming language.

FIG. 6 contains tables representing the unified parts of common operators, common data types and common build-in methods.

FIG. 7 is a schematic diagram representing an exemplary distillation of a source code snippet into distilled code.

FIG. 8 is a flow chart illustrating translation of the distilled code into source code of a different programming language.

FIG. 9 is a block diagram illustrating an exemplary operating environment.

### DETAILED DESCRIPTION

### Overview

The subject matter disclosed pertains to program translation through code distillation. An original source code snippet written in a first high-level programming language is transformed into distilled code that retains the data flow, logical structure, and core semantics of the source code snippet in a language-independent format. The language-independent format serves as a translation pivot for different programming languages. The distilled code is then translated by a decompiler into a target high-level programming language that differs from the first high-level programming language.

In the code distillation process, a source code program is parsed into a syntax tree in order to preserve the logical structure and data flow of the program. A set of distillation measures is applied to the syntax tree producing a distilled tree that contains the core semantics, logic and data flow of the original program without language-dependent code elements. The distilled tree is then reassembled by combining the nodes of the tree into string templates that output a distilled form of the code in a language-independent format.

The translation is from one high-level programming language into another high-level programming language. Intermediate code or representations used by a compiler, such as bytecodes, differ from a high-level programming language. Low-level programming languages, such as assembly code or machine language instructions, also differ from a high-level programming language.

The decompiler is a large language model that translates the distilled code into a target high-level programming language. The large language model is pre-trained on several pre-training tasks that aim to mine the hidden semantic information in the training data and obtain a more robust embedding for the translation task. Pre-training is a self-supervised learning task designed to train models to understand the syntax, context and semantics of a programming language. The model is trained on multiple high-level programming languages leveraging the distilled code as a unifying representation.

Attention now turns to a more detailed description of the system, method, and process of the program translation.

### System

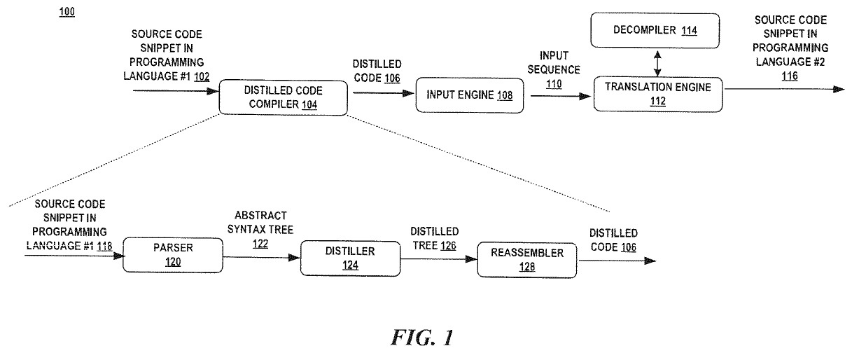

FIG. 1 illustrates an exemplary system for program translation through code distillation. The system 100 includes a distilled code compiler 104, an input engine 108, a translation engine 112, and a decompiler 114. The distilled code compiler 104 accepts a source code snippet in a first programming language 102 and generates a corresponding distilled code representation 106. In an aspect, the source code snippet 102 is a function or method. The input engine 108 accepts the distilled code 106 and transforms the distilled code into an input sequence 110 that the translation engine 112 inputs to the decompiler 114.

The distilled code compiler 104 includes a parser 120 that transforms the source code snippet 102 into an abstract syntax tree 122. The distiller 124 prunes the abstract syntax tree 122 into a distilled tree 126 using several distillation measures. The reassembler 128 converts the distilled tree 126 into the distilled code 106.

In an aspect, the decompiler 114 is configured as a neural transformer model with attention. A neural transformer model with attention is a deep learning model. The deep learning model differs from traditional machine learning models that do not use neural networks. Machine learning pertains to the use and development of computer systems that are able to learn and adapt without following explicit instructions, by using algorithms and statistical models to analyze and draw inferences from patterns in data. Machine learning uses different types of statistical methods to learn from data and to predict future decisions. Traditional machine learning includes statistical techniques, data mining, Bayesian networks, Markov models, clustering, support vector machine, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. There are various types of deep learning models that generate source code, such as recurrent neural network (RNN) models, convolutional neural network (CNN) models, long short-term memory (LSTM) models, and neural transformer models with attention.

A neural transformer model with attention utilizes an attention mechanism. Attention is used to decide which parts of the input sequence are important for each token, especially since the encoder is limited to encoding a fixed-size vector. Attention mechanisms gather information about the relevant context of a given token and then encode that context into a vector which represents the token. It is used to identity the relationships between tokens in the long sequence while ignoring other tokens that do not have much bearing on a given prediction.

The attention mechanism indicates how much attention a particular input should pay to other elements in a given input sequence. The attention mechanism can be implemented in a self-attention layer of the model. In the self-attention layer, each token in an input sequence is transformed into a query (Q), key (K), and value (V) that are used to calculate a score that indicates how much attention that particular token should attend to other tokens in the input sequence. The self-attention layers are integrated into both an encoder neural transformer model with attention and a decoder neural transformer model with attention.

The attention mechanism used in an encoder neural transformer model with attention is a self-attention layer that precedes the neural network layer. The self-attention layer attends to both the right and left of the token being calculated. The decoder neural transformer model with attention has a masked self-attention layer that precedes the neural network layer. The masked self-attention layer masks tokens to the right of the token being calculated.

Attention now turns to a more detailed description of the decompiler configured as a neural transformer model with attention.

Neural Transformer Model with Attention

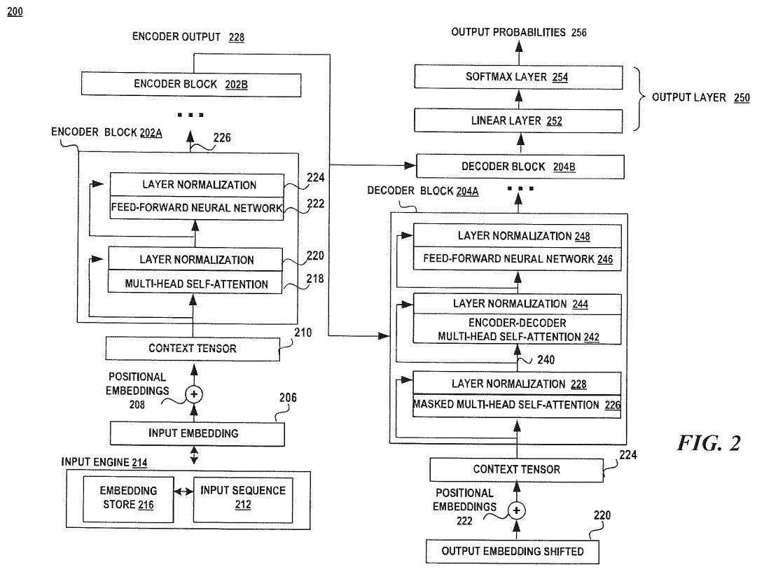

FIG. 2 shows an exemplary architecture of the decompiler as a neural transformer model with attention configured with one or more encoder blocks 202A-202B (“202”) coupled to one or more decoder blocks 204A-204B (“204”).

The initial inputs to the first encoder block 202A are the input embeddings 206 of an input sequence 212. In order to retain the order of the tokens in the input sequence 212, positional embeddings 208 are added to the input embedding 206 forming a context tensor 210.

An encoder block 202 consists of two layers. The first layer includes a multi-head self-attention component 218 followed by layer normalization component 220. The second layer includes a feed-forward neural network 222 followed by a layer normalization component 224. The context tensor 210 is input into the multi-head self-attention layer 218 of the encoder block 202 with a residual connection to layer normalization 224. The output of the layer normalization 220 is input to the feed-forward neural network 222 with another residual connection to layer normalization 224. The output of the encoder block 202A is a set of hidden representations 226. The set of hidden representations 226 is then sent through additional encoder blocks. At the last encoder block 202B, the set of hidden representations 228 is sent to the decoder blocks 204A-204B.

The multi-head self-attention component 218 takes a context tensor 210 and weighs the relevance of each token represented in the context tensor 210 to each other by generating attention weights for each token in the input embedding 206. In one aspect, the attention function is scaled dot-product attention which is described mathematically as follows:

$$Attention ( Q , K , V ) = softmax ( \frac{{QK}^{T}}{\sqrt{{d}_{k}}} ) V ,$$

where the input consists of queries Q and keys K of dimension dₖ, and values V of dimension dᵥ. Q is a matrix that contains the query or vector representation of one token in a sequence, K is the vector representations of all tokens in the sequence, and V is the vector representations of all the tokens in the sequence.

The queries, keys and values are linearly projected h times in parallel with dᵥ output values which are concatenated to a final value:

$$MultiHead ( Q , K , V ) = Concat ( {head}_{1} , … , {head}_{h} ) {W}^{o} , \\ where {head}_{i} = Attention ( {QW}_{i}^{Q} , {KW}_{i}^{K} , {VW}_{i}^{V} ) ,$$

with parameter matrices Wᵢ^{Q}ϵ [symbol] ^{d}^{_{model}}^{x d}^{ₖ}, Wᵢ^{K}ϵ [symbol] ^{d}^{_{model}}^{x d}^{ₖ}, Wᵢ^{V}ϵ [symbol] ^{d}^{_{model}}^{x d}^{ₖ}, and W^{O}ϵ [symbol] ^{hd}^{ᵥ}^{x d}^{_{model}}.

In order to reduce the training time of the neural transformer, layer normalization is used between the layers. The layer normalization component normalizes the inputs across the features. The mean and standard deviation is computed across the feature dimensions. There is a first layer normalization 220 that precedes the feed-forward neural network 222 and a second layer normalization 224 that follows the feed-forward neural network 222.

The feed-forward neural network 222 processes each output encoding separately. The output of the top encoder block is a set of attention vectors K and V 228 which is used by the encoder-decoder multi-head self-attention layer 242 of each decoder block 204.

The decoder blocks 204 predict each token tᵢ in the target programming language one-by-one at each time step conditioned on all previously-generated target tokens t₁, . . . tᵢ₋₁. Initially, the decoder block receives a language identifier symbol that identifies the target programming language to the decoder. Thereafter a shifted sequence of the output embeddings 220 from the previous time step to which the positional embeddings 222 are added forming context tensor 224.

A decoder block 204 consists of three layers. The first layer includes a masked multi-head self-attention component 226 followed by a layer normalization component 228. The output of the layer normalization component 228 is input into the encoder-decoder multi-head self-attention component 242 with a residual connection to layer normalization component 244. The second layer includes an encoder-decoder multi-head self-attention component 242 followed by a layer normalization component 244. The third layer includes a feed-forward neural network 246 followed by a layer normalization component 248. The output of layer normalization component 244 is input into the feed-forward neural network 246 with a residual connection to layer normalization component 248.

The masked multi-head self-attention component 226 receives the output embeddings of the previous timestep. The masked multi-head self-attention component 226 masks the output embeddings from future time steps. The encoder-decoder multi-head self-attention layer 242 receives queries from the previous decoder layer and the memory keys and values 228 from the output of the encoder blocks. In this manner, the decoder block 204 can attend to every position of the input sequence. The feed-forward neural network 246 processes each output encoding separately. A layer normalization component 118, 244, 248 is used between the layers in order to normalizes the inputs across the features.

The output layer 250 includes a linear layer 252 and a softmax layer 254 that generates the output probabilities 256. The linear layer 252 is a neural network that projects the vector produced by the stack of decoders into a logits vector. The softmax layer 254 then turns the scores of the logits vector into probabilities 256 for each token in the vocabulary which are positive and normalized.

In one aspect, the neural transformer model contains a stack of six encoder blocks and a stack of six decoder blocks. The output of each encoder block is passed onto the next encoder block and processed. Each decoder block receives the attention weights computed from the last encoder block. The use of multiple stacked encoder blocks and decoder blocks increases the model's capacity allowing the model to learn increasing levels of abstraction.

Pre-Training the Neural Transformer Model with Attention

Attention now turns to a discussion on pre-training the neural transformer model with attention.

A significant challenge for program translation is the lack of parallel translation pairs, that is a source code snippet in one programming language and its equivalent translation in a second programming language. To compensate for this challenge, the model is trained on several pre-training tasks using various methods that aim to mine the hidden semantic information in the training data. In an aspect, the model is pre-trained using cross-lingual masked language modeling, denoising auto-encoding, and multi-lingual program generation. These various pre-training tasks allow the model to obtain a more robust embedding for the translation task.

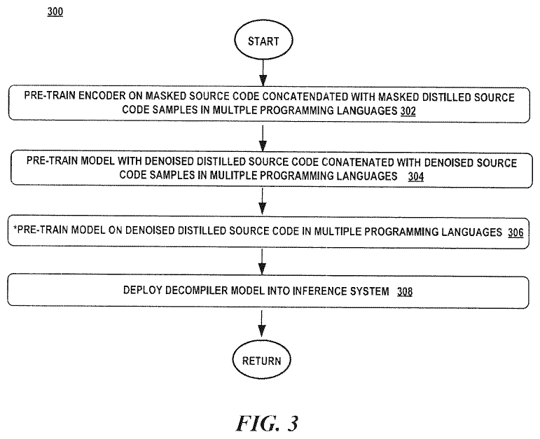

Turning to FIG. 3, there is shown an exemplary method 300 for pre-training the decompiler. The encoder blocks of the decompiler are pre-trained using a masked language modeling task (block 302), the encoder and decoder blocks are pre-trained using denoising auto-encoding (block 304), and the encoder and decoder blocks are pre-trained through multilingual program generation (block 306). Upon the completion of the various pre-training tasks, the decompiler is deployed in a target inference system (block 308).

In an aspect, the pre-training datasets include source code written in C#, C++, Java and Python. The pre-training datasets are extracted from public repositories having high-quality source code and pre-processed by deleting docstrings, comments and dead code blocks.

The masked language modeling task is a self-supervised learning task designed to train the model to understand the context and semantics of a programming language. In the masked language modeling task, tokens in the input sample are randomly masked with a masking character and the model is trained to predict the masked tokens based on the context provided by the surrounding non-masked tokens. In self-supervised learning, the model trains itself to learn one part of the input, that is the masked tokens, from another part of the input which is the context surrounding the masked tokens. (Collectively, block 302).

The pre-training dataset for the masked language modeling task contains pairs of code samples written in multiple programming languages. One part of the pair consists of the distilled code of a source code snippet having randomly masked tokens. The masked distilled code is concatenated with the original source code having randomly masked tokens. The concatenated samples are then applied to train the encoder to predict the tokens in the original source code snippet that were replaces by the random masked tokens. (Collectively, block 302).

The loss function that is used in the feed-forward layer of the encoder is the cross-entropy loss, L_{CE}, which is described as follows:

Loss=Σ_{C} L_{CE} (mask (D^{(x)}⊕x), D^{(x)}⊕x), where D^{(x)} is the distilled code for source code function x, ⊕ is the concatenation function, mask is the mask character, and C is the set of programming languages. (Collectively, block 302).

The pre-training dataset for the denoising auto-encoding task contains pairs of samples written in multiple programming languages. In the denoising autoencoding task, the model receives corrupted input (i.e., denoised input) and is trained to predict the original uncorrupted input. Both the distilled code and the corresponding original code are corrupted and then combined into an input sequence that is applied to the encoder and decoder. The denoising function may include random token shuffle, random token dropout, and sentence permutation. In random token dropout, select tokens in the training sample are randomly dropped out. Random token shuffle rearranges the order of the tokens in a training sample. Sentence permutation rearranges the order of the lines of source code in a training sample. (Collectively, block 304).

The loss function that is used in the feed-forward layer of the model is the negative log-likelihood loss, L_{LL}, which is described as follows:

Loss=Σ_{C} L_{LL} (noise (D^{(x)}⊕x), D^{(x)}⊕x), where D^{(x)} is the distilled code for source code function x, ⊕ is the concatenation function, noise is the denoising function, and Cis the set of programming languages. (Collectively, block 304).

The third pre-training task is a multilingual program generation task that assists the model in aligning distilled code to various target source code. In this task, the model starts with the denoised distilled code and learns to predict the original source code across different programming languages. The input sequence to the first decoder block includes a special language token for the target programming language (e.g., <java>, <python>). The noise is added in this pre-training stage in order for the model to more accurately distinguish the subtle differences between the distilled code from the different programming languages. After the pre-training stage, the model is able to uniformly understand distilled codes in different languages and generate corresponding target source code on the decoder side. (Collectively, block 306).

The loss function that is used in the feed-forward layers of the encoder and decoder is the negative log-likelihood loss, L_{LL}, which is described as follows:

Loss=Σ_{C} L_{LL} (noise (D^{(x)}, x), where D^{(x)} is the distilled code for source code function x, noise is the denoising function, and C is the set of programming languages. (Collectively, block 306).

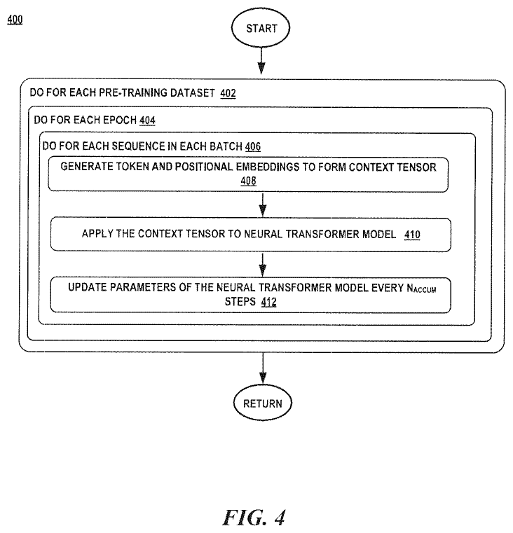

Turning to FIGS. 2 and 4, there is shown an exemplary process 400 for applying each pre-training dataset to the neural transformer model with attention. Neural transformer models with attention are trained iteratively, making multiple passes over the training dataset before converging to a minimum. An epoch represents the entire training dataset passed forwards and backwards through each neural transformer block once. Since the training dataset is very large, it is partitioned into smaller batches. The training is iterative and the entire dataset is passed through the neural transformer model with attention in multiple iterations. Each training iteration includes forward propagation, loss calculation, backpropagation steps followed by updating the weights. The training dataset is partitioned into batches with each batch of sequences running through the training process.

The neural transformer model with attention has multiple blocks and layers so that more detailed relationships within the data are learned as well as how the features interact with each other on a non-linear level. The model architecture, training procedure, data normalization and vocabulary encoding procedures are hyperparameters that are tailored to meet a particular objective. The values of the hyperparameters influence how the parameters are learned.

For each sequence of each batch in each epoch (blocks 402, 404), the T-ordered sequences of tokens are then mapped into numeric vectors and then into respective token and positional embeddings stored in the embedding store 216 (block 408). An embedding is a learned representation for the text-based tokens where tokens that have a common meaning have a common representation. An embedding is a mapping of discrete categorical variables to a vector of continuous numbers. There is an embedding for each token in the vocabulary of a particular programming language and a corresponding positional embedding. The token embedding represents the learned representation for the token. The neural transformer model with attention does not read each token sequentially and as such, has no knowledge of the token's position in a sequence without additional position information. The positional embedding is used to encode position information about a token's position in a sequence into the neural transformer model with attention. (Collectively, block 408).

Initial values are generated for the token embeddings and positional embeddings of each input sequence which are then used to form a context tensor. Thereafter, the neural transformer model with attention learns the values for each embedding. Upon the completion of the training phase, the embeddings for each token and the positional embeddings are saved into respective matrices for later use. There is a token embedding matrix, We, that contains an embedding vector for each token tᵢ, i=0 . . . V of a particular programming language, and a positional embedding matrix, Wp, that contains an embedding vector Pⱼ, j=0 . . . T, for each position, where V is the size of the vocabulary for a particular programming language and Tis the length of the token sequence. (Collectively, block 408).

The first encoder block 202A of the neural transformer model with attention takes the context tensor 210 as input and passes it through the multiple layers of multi-head attention, layer normalization and feed-forward neural network to finally produce a set of hidden representations If there are additional encoder blocks, the output of each encoder block is passed onto the next encoder block with the output of the last encoder block producing the set of hidden representations 228. The set of hidden representations is passed onto each decoder block 204. (Collectively, block 410).

The decoder blocks 204 of the neural transformer model with attention 200 take a shifted sequence of an output embedding as input. The masking in the masked multi-head attention layer 226 is used to prevent positions from attending to subsequent positions in the future. The masking combined with the output embeddings shifted by one position ensures that the predictions to position T depend only on the known outputs at positions less than T. Starting with the first token of the output sequence, the tokens are passed through the self-attention and normalization layers and into the encoder-decoder multi-head self-attention layer 242, serving as the query for encoder-decoder attention, where the key and value pairs for the attention are the outputs of encoder 228. The encoder output was calculated with the entire input embedding sequence. (Collectively, block 410).

The feed-forward neural networks in the encoder blocks 202 and the decoder blocks 204 are trained iteratively, making multiple passes over the training dataset before converging to a minimum. Each training iteration includes forward propagation, loss calculation, backpropagation steps followed by updating the weights by calculating the weight gradients. The loss function estimates the loss or error which is used to compare how good or bad the predicted results are. Once the loss is calculated, it is propagated backwards to the hidden layer that contributed directly to the output. In backpropagation, the partial derivatives of the loss function with respect to the trainable parameters are determined. The weight gradients are calculated as the difference between the old values and the new values of the weights. The weights are adjusted to make the loss as small as possible using a gradient descent technique. In one aspect, a Stochastic Gradient Descent (SGD) method is the optimization algorithm used to find the values of parameters of the function that minimizes the loss function. A backpropagation through time (BPTT) algorithm may be used to update the weights. (Collectively, block 410).

At the completion of each batch, the parameters of the neural transformer model are updated at a preconfigured frequency denoted as Naccum. Naccum is a gradient accumulation frequency and in one aspect has a value of 8. The parameters include the token embeddings and the positional embeddings which are stored in a respective embedding matrix. (Collectively, block 412).

Attention now turns to a discussion of the inference process of the program translation system.

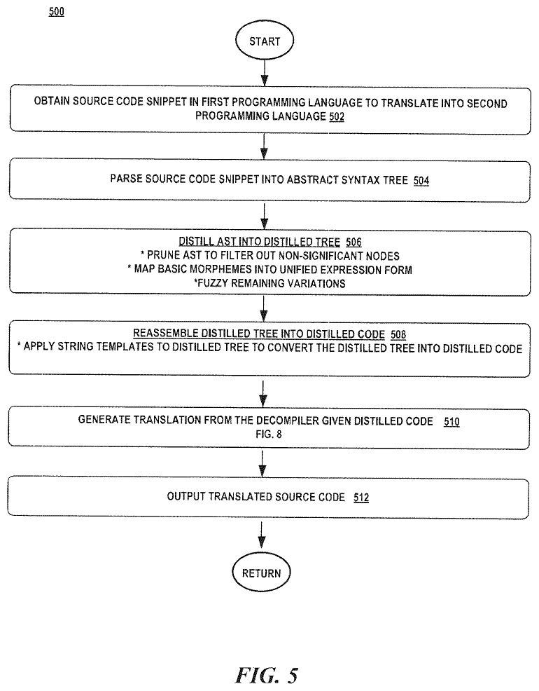

Turning to FIGS. 1 and 5, there is an exemplary method 500 of the program translation system. A source code snippet written in a first programming language is obtained to translate into a semantically-equivalent program in a different programming language (block 502). In an aspect, the source code snippet may be a method or function of a source code program. In other aspects, the source code snippet may be a complete source code program, a line of source code or portion of a source code program. The source code snippet may be obtained from a source code editor, an integrated development environment (IDE), other application or service.

The distilled code compiler 104 receives the source code snippet and uses the parser 120 to tokenize the source code and convert the tokenized source code into an abstract syntax tree (AST) (block 504). The abstract syntax tree is a tree representation of the source code snippet that retains the structure of the source code and meaning of the code but eliminates extraneous nodes of the tree (block 504).

The distilled code compiler 104 converts the AST into distilled code using several distillation measures (block 506). The distillation measures determine which nodes of the abstract syntax tree can be removed without compromising the model's ability to comprehend the source code snippet. The distillation measures aim to preserve the components of the source code having the most influence on the semantic understanding of a source code program, such as the identifiers (e.g., variable names, function/method names, data types, and reserved keywords) and structure-related symbols (logic and control flow keywords, such as, if statements, for loops, while loops, context managers, etc.), and remove from the abstract syntax tree the source code components that have the least influence on the semantic understanding of the source code. The identifiers are the terminal nodes of the abstract syntax tree which represent objects, functions, and types in the programming language. Structure-related symbols denote sub-trees of the abstract syntax tree which define control flow and logic in the programming language.

The distiller 124 prunes the non-significant nodes from the AST. The non-significant nodes include modifiers, return types, code comments and some components of the expression like new expression, namespace identifiers, templates, dependents, and constructors since they contain relatively little useful information and do not reduce the translation quality. (Collectively, block 506).

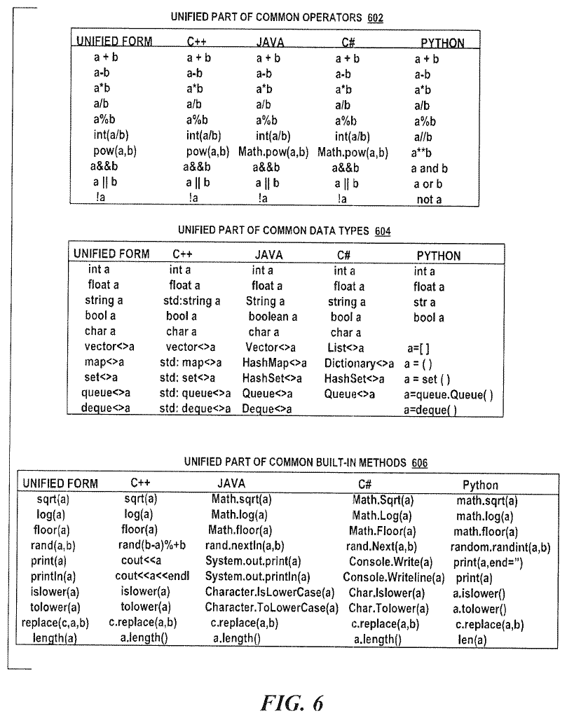

The distilled code compiler 104 maps basic morphemes of the different programming languages into a unified form (block 506). A morpheme is a source code element in a programming language that cannot be subdivided into a smaller meaningful unit, such as an operator, data type or built-in function. Turning to FIG. 6, there is shown the unified forms for common operators 602, common data types 604, and common built-in functions 606. The operators, data types and built-in functions contained in a AST are transformed into a corresponding unified form. There are also unique expressions in each programming language that are not supported in other programming languages. For these unique expressions, a similar unified form is substituted for the unique expression that produces the same result. For example, the switch expression in Java in not supported in Python and is substituted with an if-else structure that achieves the same result.

In the fuzzy remaining variations step, all remaining words in camel-case and snake-case are decomposed and further split into sub-word forms, where all uppercase letters are rewritten to lowercase, and finally they are wrapped by a special prefix “BOW:”. Camel-case is a convention in which an initial capital is used for the first letter of a word forming the second element of a closed compound word. Snake-case is the convention in which each space is replaced with an underscore character and the first letter of each word is lowercase. For example, the camel-case word CreateClient in the expression Client client.CreateClient ( ) is converted into BOW: create client. This transition is done to reduce the detailed dependence of such words in different programming languages by obfuscation and de-obfuscation. This approach is common when dealing with function calls from complex external dependencies and other special expressions. (Collectively, block 506).

The distiller 124 outputs the distilled tree 126 and the reassembler 128 reassembles the distilled tree into a format acceptable for use with the decompiler 114. Special string templates are used to construct the distilled code. The string templates represent a design pattern common among different programming languages for morphemes shared by all the programming languages, such as for loops, while loops, if statements, etc. For example, the string template of a for loop is for (initialization; condition; update), {consequence}. The string template of a while loop is while (condition), {consequence}. The string template of if statement is if (condition), {consequence}; else {alternative}. (Collectively, block 508).

The decompiler generates the translated code given the distilled code (block 510) which is then output in the target system (block 512).

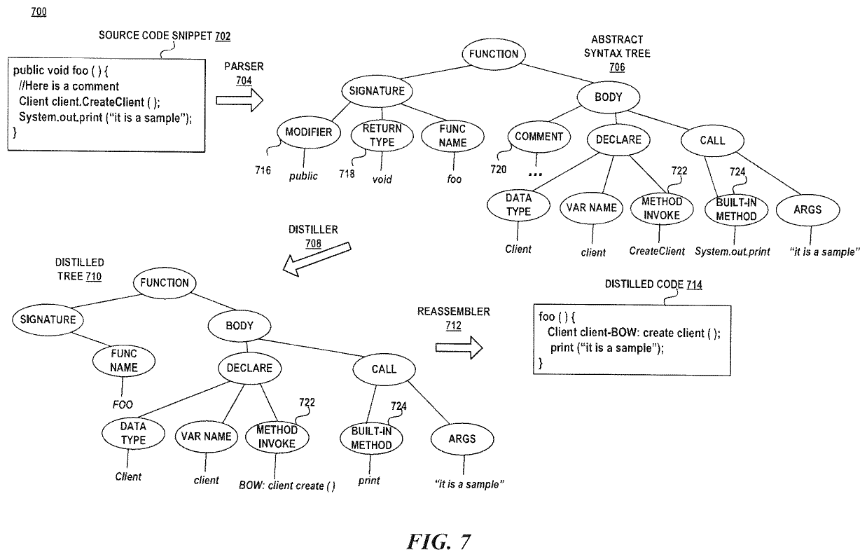

Turning to FIG. 7, there is shown an exemplary illustration of the distillation process 700. A parser 704 parses a source code snippet 702 into an abstract syntax tree 706. The source code snippet is the method foo ( ) which contains a method signature, public void foo ( ), a comment line, /Here is a comment, the expression Client client.CreateClient ( ) which invokes the method client.CreateClient having a data type of Client, and the expression System.out.print (“it is a sample”). The abstract syntax tree 706 contains the standard abstract syntax tree nodes as defined by the grammar of the programming language.

The distiller 708 trims the abstract syntax tree 706 to eliminate the modifier 716, return type 718 and comment 720 nodes of the tree 706 since these nodes are considered non-significant nodes. The non-significant nodes will not adversely affect the model's understanding of the overall code. The distiller 708 associates BOW: client create with the method invoke node 722 and associates the unify built-in method print for the built-in method node 724. The reassembler 712 traverses the distilled tree 710 to construct the distilled code 714 using the string templates.

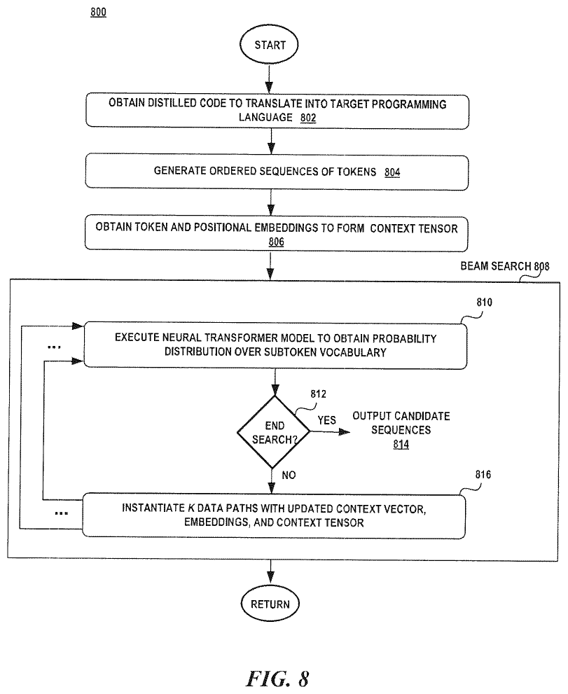

Turning to FIGS. 1 and 8, there is shown an exemplary method of the decompiler to predict a translation for a given distilled code 800. The input engine 108 receives the distilled code 106 to translate into a target programming language (block 802). The input engine 108 converts the distilled code into an input sequence of tokens (block 804) and then into a sequence of token embeddings with corresponding positional embeddings to form the context tensor (block 806). The embeddings were learned for each token during the training of the model and are shared between all languages.

The translation engine 112 performs a beam search (block 808) to generate k translation candidate sequences, where k is a preconfigured value (block 810). A translation candidate sequence is a translation generated by the neural transformer model with attention.

The beam search uses the probability distribution generated by the neural transformer model with attention to identify the top k tokens likely to be the next token in a translation candidate sequence. The beam search expands the search by instantiating new partial sequences using each of the selected tokens identified by the neural transformer model's probability distribution. The search continues generating new partial sequences from the top k tokens identified by the output distributions until the search ends. The search may end when the end-of-method token appears as the most probable next token or the maximum length threshold is exceeded. (Collectively, block 810).

The beam search 800 uses a breadth-first search to build a search tree. The search tree is composed of nodes at one or more inference levels. Each node represents a probability distribution generated by the neural transformer model for the tokens in the model vocabulary. At each level, only the top k tokens having the highest probabilities from the output distribution generated by the neural transformer model are expanded to the next inference level. The variable k is preconfigured and referred to as the beam width. Each of the k tokens is then expanded into a search that updates the current translation candidate sequence with the selected token to input into the neural transformer model to generate an additional probability distribution for the next token in a sequence. This process is repeated until the end-of-method token appears as the most probable next token or the maximum length threshold is exceeded. (Collectively, block 810)

The beam search uses the neural transformer model with attention with the context tensor to generate a probability distribution for the token vocabulary at each decoder time step (block 810). If the probability distribution indicates that the next likely token is the end-of-method token or the maximum sequence length threshold has been exceeded, then the beam search is finished and the candidate sequences are output (block 812—yes). Otherwise (block 812—no), the top k tokens to complete a partial sequence are selected (block 816).

Each of the selected tokens is then input in a respective context vector and has a separate data path through the neural transformer model again. The context vector utilizes the selected token in the current context vector with the last token removed. The new context vector will consist of T tokens with the selected token tₖ added to the beginning of the sequence with the last token removed from the sequence. If the current context vector consists of a token sequence consisting of t₀, t₁, . . . , t_{T}, then the new context vector will consist of tₖ, t₀, t₁, . . . , t_{T-1}. (Collectively, block 816).

### Technical Effect

Aspects of the subject matter disclosed herein pertain to the technical problem of translating a source code snippet written in a first high-level programming language into a semantically-equivalent source code program in a different high-level programming language. The technical features include the distillation of the source code snippet into distilled code and the translation of the distilled code using a decompiler constructed as a deep learning model. The technical effect achieved is the increased accuracy in the translated source code snippet with reduced computational expense.

The operations performed in the generation of the distilled code and the translation are complex. Hence, the operations performed are inherently digital. A human mind cannot interface directly with a CPU, or network interface card, or other processor, or with RAM or digital storage, to read and write the necessary data and perform the necessary operations and processing steps taught herein.

Embodiments are also presumed to be capable of operating “at scale”, that is capable of handling larger volumes, in production environments or in testing labs for production environments as opposed to being mere thought experiments.

### Exemplary Operating Environment

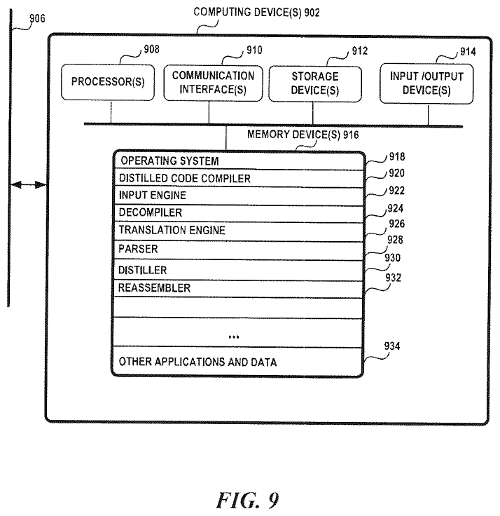

Attention now turns to a discussion of an exemplary operating environment. FIG. 9 illustrates an exemplary operating environment 900 in which one or more computing devices 902 are used to perform the translation. However, it should be noted that the aspects disclosed herein is not constrained to any particular configuration of devices. Computing devices 902 may be configured as a cloud service that offers translation as a service. In another aspect, the decompiler may reside in one computing device and the distilled code compiler may reside in a different computing device.

A computing device 902 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 1400 may be configured in a network environment, a distributed environment, a multi-processor environment, or a stand-alone computing device having access to remote or local storage devices.

The computing device 902 may include one or more processors 908, one or more communication interfaces 910, one or more storage devices 912, one or more input/output devices 914, and one or more memory devices 916. A processor 908 may be any commercially available or customized processor and may include dual microprocessors and multi-processor architectures. A communication interface 910 facilitates wired or wireless communications between the computing device 902 and other devices. A storage device 912 may be computer-readable medium that does not contain propagating signals, such as modulated data signals transmitted through a carrier wave. Examples of a storage device 912 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 912 in the computing device 902. The input/output devices 914 may include a keyboard, mouse, pen, voice input device, touch input device, display, speakers, printers, etc., and any combination thereof.

A memory device or memory 916 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory 916 may also include one or more external storage devices or remotely located storage devices that do not pertain to propagated signals, such as modulated data signals transmitted through a carrier wave.

The memory device 916 may contain instructions, components, and data. A component is a software program that performs a specific function and is otherwise known as a module, program, component, and/or application. The memory device 916 may include an operating system 918, a distilled code compiler 920, an input engine 922, a decompiler 924, translation engine 926, a parser 928, a distiller 930, a reassembler 932, and other applications and data 934.

The computing devices 902 may be communicatively coupled via a network 906. The network 906 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 906 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

What is claimed:

1. A system for source code translation, comprising:
a processor; and
a memory that stores a program including instructions to be executed on the processor to perform acts that:
obtain a first source code snippet comprising source code of a first high-level programming language;
transform the first source code snippet into distilled code, wherein the distilled code comprises language-independent code elements;
provide the distilled code to a decompiler for translation into a second high-level programming language;
obtain a translation of the distilled code into source code of the second high-level programming language, wherein the first high-level programming language and the second programming language differ.

2. The system of claim 1, wherein the program includes further instructions to be executed on the processor to perform acts that:
convert the first source code snippet into a syntax tree, wherein the syntax tree comprises a plurality of nodes; and
prune non-significant nodes from the syntax tree, wherein a non-significant node includes a comment, modifier, and return type.

3. The system of claim 2, wherein the program includes further instructions to be executed on the processor to perform acts that:
map a basic morpheme found in a node of the syntax tree into a unified code form.

4. The system of claim 3, wherein the basic morpheme comprises common operators, common data types and common built-in functions.

5. The system of claim 2, wherein the program includes further instructions to be executed on the processor to perform acts that:
reassemble the nodes of the syntax tree into the distilled code using a plurality of string templates, wherein a string template includes a language-independent code pattern.

6. The system of claim 1, wherein the decompiler is a neural transformer model with attention.

7. The system of claim 1, wherein the decompiler is pre-trained on a masked language modeling task, a denoising auto-encoding task, and a multilingual program generation task.

8. A computer-implemented method for source code translation, comprising:
receiving an original source code snippet in a first high-level programming language;
parsing the original source code snippet into a syntax tree having a plurality of nodes;
converting the syntax tree into a distilled tree by pruning nodes of the syntax tree that represent modifiers, return types and comments and replacing common operators, data types and built-in functions with a unified code form;
transforming the distilled tree into distilled code, wherein the distilled code comprises logic flow and data flow of the original source code snippet in a language-independent format; and
generating a semantically-equivalent source code program for the original source code snippet in a second high-level programming language from a decompiler given the distilled code, wherein the first high-level programming language and the second high-level programming language differ.

9. The computer-implemented method of claim 8, further comprising:
applying string templates to nodes of the distilled tree to generate the distilled code in the language-independent format.

10. The computer-implemented method of claim 8, further comprising:
segmenting function calls in the distilled tree having camel-case and snake-case names into subword forms.

11. The computer-implemented method of claim 8, further comprising:
substituting a unique expression used only in a particular programming language into a semantically-equivalent common expression.

12. The computer-implemented method of claim 8, wherein the decompiler is a neural transformer model with attention.

13. The computer-implemented method of claim 12, wherein the neural transformer model with attention is pre-trained on a masked language modeling task using a training dataset of samples, wherein each sample comprises a masked distilled code snippet concatenated with a corresponding distilled code snippet.

14. The computer-implemented method of claim 12, wherein the neural transformer model with attention is pre-trained on a denoising auto-encoding task using a training dataset of samples, wherein each sample comprises a denoised distilled code snippet concatenated with a corresponding distilled code snippet.

15. The computer-implemented method of claim 12, wherein the neural transformer model with attention is pre-trained on a multilingual program generation task using training dataset of samples, wherein each sample comprises a distilled code snippet.

16. A computer-implemented method for source code translation, comprising:
distilling a source code snippet into distilled source code, wherein the distilled source code comprises logic flow and data flow of the source code snippet in language-independent code constructs, wherein the source code snippet comprises source code of a first programming language;
masking the distilled source code;
concatenating the masked distilled code with the distilled code representation; and
pre-training the decompiler to learn to translate the distilled code into source code of a second programming language given the concatenated masked distilled code with the distilled code representation, wherein the first programming language and the second programming language differ.

17. The computer-implemented method of claim 16, further comprising:
denoising the distilled code;
concatenating the denoised distilled code with the distilled code; and
pre-training the decompiler to learn to translate the distilled code into source code of a second programming language given the concatenated denoised distilled code with the distilled code, wherein the first programming language and the second programming language differ.

18. The computer-implemented method of claim 17, further comprising:
pre-training the decompiler to learn to translate the distilled code into source code of a second programming language given the distilled code.

19. The computer-implemented method of claim 18, further comprising:
obtaining a second source code snippet comprising source code of the first programming language;
converting the second source code snippet into a second distilled code;
providing the second distilled code to the decompiler; and
obtaining a translation of the second distilled code in the second programming language from the decompiler.

20. The computer-implemented method of claim 16, wherein the decompiler is a neural transformer model with attention.
